(19) United States
(12) Patent Application Publication
(10) Pub. No.: US 2018/0155490 A1
(43) Pub. Date: Jun. 7, 2018

(54) BIODEGRADABLE POLYOLS HAVING HIGHER BIOBASED CONTENT

(71) Applicant: Novomer, Inc., Waltham, MA (US)

(72) Inventor: Sadesh H. Sookraj, Cambridge (ZA)

(21) Appl. No.: 15/369,821

(22) Filed: Dec. 5, 2016

(51) Int. Cl. C08G 63/08

(52) U.S. Cl. CPC C08G 63/08

(57) ABSTRACT

The present invention is directed to biodegradable polyester polyol polymers having high bio-based content and methods for producing biodegradable polyester polyol polymers having high bio-based content. In preferred embodiments, β-lactone monomers may be produced from epoxide and carbon monoxide having high bio-based content. In certain preferred embodiment, the β-lactone is β-propiolactone produced from ethylene oxide and carbon monoxide. In certain embodiments, β-lactones may be polymerized with diols, triols, and polyols to form the biodegradable polyester polyol polymers having high bio-based content. In some embodiments, the biodegradable polyester polyol polymers having high bio-based content may be terpolymers formed from a first β-lactone, a diol, triol, or polyol, and a second β-lactone. In some other embodiments, the biodegradable polyester polyol polymers having high bio-based content may be copolymers formed from a polylactone oligomer and a diol, triol, or polyol.

### FIELD OF THE INVENTION

The present invention is generally directed to environmentally responsible polyester polyol polymers, derivatives, and to the processes for producing the polyester polyol polymers and derivatives. Specifically, preferred polymerization processes include monomers comprised of carbons obtained from biological, recycled, renewable, or otherwise sustainable raw material sources. Advantageously, the unique characteristics of the polyol polymers are ideal for use in environmentally responsible applications.

### BACKGROUND OF THE INVENTION

For the purposes of this invention, the terms “biobased”, “biobased content”, and “bio-content” are used interchangeably to describe carbon atoms from biological sources, recycled sources, renewable sources, and/or otherwise sustainable sources. Carbon atoms are fundamental building blocks for many manufactured materials due to unique physical and chemical characteristics. One important use of carbon atoms is in the manufacture of polymers.

Generally, a polymer is a larger molecule comprised of multiple repeated smaller molecules known as monomers. During a process known as polymerization, the monomers may be covalently bonded to each other forming larger polymer chains. The composition and arrangement of the monomers may determine the characteristics of the polymer, for example, determining the biodegradability and biobased content of the polymer.

The biobased content of the polymer relates to the raw material sources from which the monomers are derived. Specifically, the degree of biobased content depends on the amount of carbons in the monomers which are derived from biological sources, recycled sources, renewable sources, or otherwise sustainable sources. Such materials may include sources such as crop residues, wood residues, grasses, municipal solid waste and algae. A polymer with higher biobased content may be preferable for use in sustainable and environmentally responsible applications.

Biodegradable polymers may also be beneficial in environmentally responsible applications. Biodegradable polymers generally include a main chain comprised of bonded organic molecules which may decompose by natural processes into smaller environmentally compatible molecules. The specific chemical composition of the monomers in the biodegradable polymers will determine what smaller molecules are produced by decomposition, the mechanisms by which decomposition occurs, and the rate at which decomposition occurs.

Many conventional polymers may not be comprised of monomers which confer characteristics of biodegradability or some degree of biobased content. In addition, modifying conventional processes to produce environmentally responsible polymers may be costly, require long production cycles, and/or be difficult to modify.

Polyester polyol polymers (“polyols”) are generally biodegradable polymers which have exceptional compositions and arrangements which make the polyols a key material in the production of many products. The production of polyols by the reaction of polycarboxylic acids, anhydrides or esters of polycarboxylic acids with polyhydric alcohols is well known. Generally, the processes of the prior art involve a one-step reaction of a polycarbonate source with a stoichiometric excess of a polyhydric alcohol. These processes utilize large and expensive reactors with limited reagents resulting in less modifiable products.

There exists a need for highly customizable biodegradable polyols with higher biobased content which may be produced by more versatile and cost efficient processes.

The present invention satisfies this need by providing biodegradable polyols with higher biobased content produced by processes which more efficiently use raw material sources having a high degree of biobased content.

### SUMMARY OF THE INVENTION

The present invention is directed to biodegradable polyols with higher biobased content and methods for production. The polyols of the present invention are produced through innovative processes to impart unique characteristics.

In preferred embodiments, the monomers of the polyols may be produced, from biologically sourced, renewable, recycled, and/or sustainable sources of carbon. In certain preferred embodiments, β-lactone monomers may be produced from carbonylation of an epoxide with carbon monoxide. The epoxide sources and carbon monoxide sources may have high biobased carbon content. The β-lactone monomers may be reacted with monomers with hydroxyl functional groups such as simple alcohols, diols, triols, polyols, and sugar alcohols with high biobased carbon content. Advantageously, the polyols of the present invention may have increased biodegradability and may have increased biobased content. In certain preferred embodiments, the polyols may be a terpolymer polymerized from two distinct β-lactone monomers and a monomer having hydroxyl functional groups. In certain preferred embodiments, the polyols may be formed by polymerizing poly-lactone oligomers with monomers having hydroxyl functional groups. In certain preferred embodiments, the polyols may be further reacted with β-lactone monomers with higher biobased content to produce modified polyols with higher biobased content.

Some aspects of this invention provide a polyol produced from a feed stream of β-lactone and a comonomer where the β-lactone is obtained by the carbonylation of an epoxide and carbon monoxide and wherein at least a portion of the epoxide contains carbon from bio-mass sources, also known as biogenic carbon. In preferred aspects of this invention all of the epoxide is derived from biogenic carbon. In highly preferred aspects of this invention all of the epoxide and carbon monoxide is derived from biogenic carbon.

Accordingly, in one aspect the invention is a method for producing a β-propiolactone copolymer having from renewable carbon content. In this aspect a β-propiolactone monomer may be derived having biogenic carbon content. Preferably at least a portion of the β-propiolactone monomer is produced by the carbonylation of ethylene oxide having a bio-content of at least 10% with carbon monoxide that optionally has a biocontent of at least 10% and a comonomer derived from a lactone other than beta-propiolactone.

The ability to use β-lactones derived at least in part from epoxides and carbon monoxide containing renewable and recycled carbon magnifies the environmental benefit obtained from the polymers of this invention and the production methods of this invention.

Preferred embodiments of the present invention include versatile processes for cost effective production of the polyols by polymerizing β-lactone monomers and monomers including hydroxyl functional groups in a condensation polymerization reaction zone. Certain embodiments of the processes include recovering high biobased content β-lactone monomers from a β-lactone intermediate formed by combining at least an epoxide, carbon monoxide, and carbonylation catalyst in a carbonylation reaction zone. Advantageously, the polyols produced from the high biobased content β-lactone may have higher biobased content and biodegradability.

In preferred applications of this invention the polyols described herein, may be suitable for use as thermoplastics having low melting temperatures. Such uses include biodegradable foams, packaging, coatings, adhesives, surfactants, and elastomers. Advantageously, applications incorporating embodiments of the present invention may be more biodegradable than applications using some other alternative polymers. A further advantage to applications using embodiments of the present invention is a decreased carbon footprint resulting from polyols comprised of biobased components.

While this disclosure is susceptible to various modifications and alternative forms, specific exemplary embodiments have been shown by way of example in the drawings and described in detail. There is no intent to limit the disclosure to the specific exemplary embodiments disclosed. The intention is to cover all modifications, equivalents, and alternatives falling within the scope of the disclosure as defined by the appended claims.

### DETAILED DESCRIPTION OF EMBODIMENTS

The following description includes preferred embodiments of the present invention which are directed to biodegradable polyol polymers having higher biobased carbon content. It should be recognized, however, that such description is not intended as a limitation on the scope of the present disclosure but is instead provided as a description of exemplary aspects.

Definitions of specific functional groups and chemical terms are described in more detail below. The chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito, 1999; Smith and March March's Advanced Organic Chemistry, 5^{th} Edition, John Wiley & Sons, Inc., New York, 2001; Larock, Comprehensive Organic Transformations, VCH Publishers, Inc., New York, 1989; Carruthers, Some Modern Methods of Organic Synthesis, 3^{rd} Edition, Cambridge University Press, Cambridge, 1987; the entire contents of each of which are incorporated herein by reference.

The terms “halo” and “halogen” as used herein refer to an atom selected from fluorine (fluoro, —F), chlorine (chloro, —Cl), bromine (bromo, —Br), and iodine (iodo, —I). The terms “halide” as used herein refer to a halogen bearing a negative charge selected from flouride —F⁻, chloride —Cl⁻, bromide —Br⁻, and iodide —I⁻.

The term “aliphatic” or “aliphatic group”, as used herein, denotes a hydrocarbon moiety that may be straight-chain (i.e., unbranched), branched, or cyclic (including fused, bridging, and spiro-fused polycyclic) and may be completely saturated or may contain one or more units of unsaturation, but which is not aromatic. Unless otherwise specified, aliphatic groups contain 1-30 carbon atoms. In some aspects, aliphatic groups contain 1-12 carbon atoms. In some aspects, aliphatic groups contain 1-8 carbon atoms. In some aspects, aliphatic groups contain 1-6 carbon atoms. In some aspects, aliphatic groups contain 1-5 carbon atoms, in some aspects, aliphatic groups contain 1-4 carbon atoms, in yet other aspects aliphatic groups contain 1-3 carbon atoms, and in yet other aspects, aliphatic groups contain 1-2 carbon atoms. Suitable aliphatic groups include, but are not limited to, linear or branched, alkyl, alkenyl, and alkynyl groups, and hybrids thereof such as (cycloalkyl)alkyl, (cycloalkenyl)alkyl or (cycloalkyl)alkenyl.

The term “heteroaliphatic,” as used herein, refers to aliphatic groups wherein one or more carbon atoms are independently replaced by one or more atoms selected from the group consisting of oxygen, sulfur, nitrogen, phosphorus, or boron. In some aspects, one or two carbon atoms are independently replaced by one or more of oxygen, sulfur, nitrogen, or phosphorus. Heteroaliphatic groups may be substituted or unsubstituted, branched or unbranched, cyclic or acyclic, and include “heterocycle,” “heterocyclyl,” “heterocycloaliphatic,” or “heterocyclic” groups.

The term “acrylate” or “acrylates” as used herein refer to any acyl group having a vinyl group adjacent to the acyl carbonyl. The terms encompass mono-, di- and tri-substituted vinyl groups. Examples of acrylates include, but are not limited to: acrylate, methacrylate, ethacrylate, cinnamate (3-phenylacrylate), crotonate, tiglate, and senecioate.

The term “polymer”, as used herein, refers to a molecule of high relative molecular mass, the structure of which comprises the multiple repetitions of units derived, actually or conceptually, from molecules of low relative molecular mass. In some aspects, a polymer is comprised of only one monomer species (e.g., polyEO). In some aspects, a polymer is a copolymer, terpolymer, heteropolymer, block copolymer, or tapered heteropolymer of one or more epoxides.

The term “unsaturated”, as used herein, means that a moiety has one or more double or triple bonds.

The terms “cycloaliphatic”, “carbocycle”, or “carbocyclic”, used alone or as part of a larger moiety, refer to a saturated or partially unsaturated cyclic aliphatic monocyclic, bicyclic, or polycyclic ring systems, as described herein, having from 3 to 12 members, wherein the aliphatic ring system is optionally substituted as defined above and described herein. Cycloaliphatic groups include, without limitation, cyclopropyl, cyclobutyl, cyclopentyl, cyclopentenyl, cyclohexyl, cyclohexenyl, cycloheptyl, cycloheptenyl, cyclooctyl, cyclooctenyl, and cyclooctadienyl. In some aspects, the cycloalkyl has 3-6 carbons. Representative carbocyles include cyclopropane, cyclobutane, cyclopentane, cyclohexane, bicyclo[2,2,1]heptane, norbornene, phenyl, cyclohexene, naphthalene, and spiro[4.5]decane. The terms “cycloaliphatic”, “carbocycle” or “carbocyclic” also include aliphatic rings that are fused to one or more aromatic or nonaromatic rings, such as decahydronaphthyl or tetrahydronaphthyl, where the radical or point of attachment is on the aliphatic ring. In some aspects, a carbocyclic group is bicyclic. In some aspects, a carbocyclic group is tricyclic. In some aspects, a carbocyclic group is polycyclic.

The term “alkyl,” as used herein, refers to saturated, straight- or branched-chain hydrocarbon radicals derived from an aliphatic moiety containing between one and six carbon atoms by removal of a single hydrogen atom. Unless otherwise specified, alkyl groups contain 1-12 carbon atoms. In some aspects, alkyl groups contain 1-8 carbon atoms. In some aspects, alkyl groups contain 1-6 carbon atoms. In some aspects, alkyl groups contain 1-5 carbon atoms, in some aspects, alkyl groups contain 1-4 carbon atoms, in yet other aspects, alkyl groups contain 1-3 carbon atoms, and in yet other aspects alkyl groups contain 1-2 carbon atoms. Examples of alkyl radicals include, but are not limited to, methyl, ethyl, n-propyl, isopropyl, n-butyl, iso-butyl, sec-butyl, sec-pentyl, iso-pentyl, tert-butyl, n-pentyl, neopentyl, n-hexyl, sec-hexyl, n-heptyl, n-octyl, n-decyl, n-undecyl, dodecyl, and the like.

The term “aryl” used alone or as part of a larger moiety as in “aralkyl”, “aralkoxy”, or “aryloxyalkyl”, refers to monocyclic and polycyclic ring systems having a total of five to 20 ring members, wherein at least one ring in the system is aromatic and wherein each ring in the system contains three to twelve ring members. The term “aryl” may be used interchangeably with the term “aryl ring”. In some aspects, “aryl” refers to an aromatic ring system which includes, but is not limited to, phenyl, naphthyl, anthracyl and the like, which may bear one or more substituents. Also, included within the scope of the term “aryl”, as it is used herein, is a group in which an aromatic ring is fused to one or more additional rings, such as benzofuranyl, indanyl, phthalimidyl, naphthimidyl, phenanthridinyl, or tetrahydronaphthyl, and the like.

The terms “heteroaryl” and “heteroar-”, used alone or as part of a larger moiety, e.g., “heteroaralkyl”, or “heteroaralkoxy”, refer to groups having 5 to 14 ring atoms, preferably 5, 6, 9 or 10 ring atoms; having 6, 10, or 14 p electrons shared in a cyclic array; and having, in addition to carbon atoms, from one to five heteroatoms. The term “heteroatom” refers to nitrogen, oxygen, or sulfur, and includes any oxidized form of nitrogen or sulfur, and any quaternized form of a basic nitrogen. Heteroaryl groups include, without limitation, thienyl, furanyl, pyrrolyl, imidazolyl, pyrazolyl, triazolyl, tetrazolyl, oxazolyl, isoxazolyl, oxadiazolyl, thiazolyl, isothiazolyl, thiadiazolyl, pyridyl, pyridazinyl, pyrimidinyl, pyrazinyl, indolizinyl, purinyl, naphthyridinyl, benzofuranyl and pteridinyl. The terms “heteroaryl” and “heteroar-”, as used herein, also include groups in which a heteroaromatic ring is fused to one or more aryl, cycloaliphatic, or heterocyclyl rings, where the radical or point of attachment is on the heteroaromatic ring. Non-limiting examples include indolyl, isoindolyl, benzothienyl, benzofuranyl, dibenzofuranyl, indazolyl, benzimidazolyl, benzthiazolyl, quinolyl, isoquinolyl, cinnolinyl, phthalazinyl, quinazolinyl, quinoxalinyl, 4H-quinolizinyl, carbazolyl, acridinyl, phenazinyl, phenothiazinyl, phenoxazinyl, tetrahydroquinolinyl, tetrahydroisoquinolinyl, and pyrido[2,3-b]-1,4-oxazin-3(4H)-one. A heteroaryl group may be monocyclic or bicyclic. The term “heteroaryl” may be used interchangeably with the terms “heteroaryl ring”, “heteroaryl group”, or “heteroaromatic”, any of which terms include rings that are optionally substituted. The term “heteroaralkyl” refers to an alkyl group substituted by a heteroaryl, wherein the alkyl and heteroaryl portions independently are optionally substituted.

As used herein, the terms “heterocycle”, “heterocyclyl”, “heterocyclic radical”, and “heterocyclic ring” are used interchangeably and refer to a stable 5- to 7-membered monocyclic or 7- to 14-membered bicyclic heterocyclic moiety that is either saturated or partially unsaturated, and having, in addition to carbon atoms, one or more, preferably one to four, heteroatoms, as defined above. When used in reference to a ring atom of a heterocycle, the term “nitrogen” includes a substituted nitrogen. As an example, in a saturated or partially unsaturated ring having 0-3 heteroatoms selected from oxygen, sulfur or nitrogen, the nitrogen may be N (as in 3,4-dihydro-2H-pyrrolyl), NH (as in pyrrolidinyl), or ⁺NR (as in N-substituted pyrrolidinyl).

A heterocyclic ring can be attached to its pendant group at any heteroatom or carbon atom that results in a stable structure and any of the ring atoms can be optionally substituted. Examples of such saturated or partially unsaturated heterocyclic radicals include, without limitation, tetrahydrofuranyl, tetrahydrothienyl, pyrrolidinyl, pyrrolidonyl, piperidinyl, pyrrolinyl, tetrahydroquinolinyl, tetrahydroisoquinolinyl, decahydroquinolinyl, oxazolidinyl, piperazinyl, dioxanyl, dioxolanyl, diazepinyl, oxazepinyl, thiazepinyl, morpholinyl, and quinuclidinyl. The terms “heterocycle”, “heterocyclyl”, “heterocyclyl ring”, “heterocyclic group”, “heterocyclic moiety”, and “heterocyclic radical”, are used interchangeably herein, and also include groups in which a heterocyclyl ring is fused to one or more aryl, heteroaryl, or cycloaliphatic rings, such as indolinyl, 3H-indolyl, chromanyl, phenanthridinyl, or tetrahydroquinolinyl, where the radical or point of attachment is on the heterocyclyl ring. A heterocyclyl group may be mono- or bicyclic. The term “heterocyclylalkyl” refers to an alkyl group substituted by a heterocyclyl, wherein the alkyl and heterocyclyl portions independently are optionally substituted.

As used herein, the term “partially unsaturated” refers to a ring moiety that includes at least one double or triple bond. The term “partially unsaturated” is intended to encompass rings having multiple sites of unsaturation, but is not intended to include aryl or heteroaryl moieties, as herein defined.

As described herein, compounds may contain “optionally substituted” moieties. In general, the term “substituted”, whether preceded by the term “optionally” or not, means that one or more hydrogens of the designated moiety are replaced with a suitable substituent. Unless otherwise indicated, an “optionally substituted” group may have a suitable substituent at each substitutable position of the group, and when more than one position in any given structure may be substituted with more than one substituent selected from a specified group, the substituent may be either the same or different at every position. Combinations of substituents envisioned may include those that result in the formation of stable or chemically feasible compounds. The term “stable”, as used herein, refers to compounds that are not substantially altered when subjected to conditions to allow for their production, detection, and, in some aspects, their recovery, purification, and use for one or more of the purposes disclosed herein.

In some chemical structures, substituents are shown attached to a bond which crosses a bond in a ring of the depicted molecule. This means that one or more of the substituents may be attached to the ring at any available position (usually in place of a hydrogen atom of the parent structure). In cases where an atom of a ring so substituted has two substitutable positions, two groups may be present on the same ring atom. When more than one substituent is present, each is defined independently of the others, and each may have a different structure. In cases where the substituent shown crossing a bond of the ring is —R, this has the same meaning as if the ring were said to be “optionally substituted” as described in the preceding paragraph.

As used herein, the term “catalyst” refers to a substance the presence of which increases the rate of a chemical reaction, while not being consumed or undergoing a permanent chemical change itself.

Renewable sources means a source of carbon and/or hydrogen obtained from biological life forms that can replenish itself in less than one hundred years.

Renewable carbon means carbon obtained from biological life forms that can replenish itself in less than one hundred years.

Recycled sources mean carbon and/or hydrogen recovered from a previous use in a manufactured article.

Recycled carbon means carbon recovered from a previous use in a manufactured article.

Biodegradability and biodegradable refers to the ability of a material to be broken down (decomposed) rapidly by the action of living organisms such as bacteria, fungi, microorganisms or other biological means wherein rapidly typically less than 10 years, 5 years, for 2 years.

Sustainable material and sustainable polymer means a biodegradable material and polymer, respectively, that is derived at least in part from sources with bio-content and has a bio-content equal to a minimum of 10%, and more typically 20%, 50%, 75%, 90%, 95%, or 100% of the total amount of carbon and hydrogen in the material.

As used herein, the term “about” preceding one or more numerical values means the numerical value ±5%. It should be understood that reference to “about” a value or parameter herein includes (and describes) aspects that are directed to that value or parameter per se. For example, description referring to “about x” includes description of “x” per se.

Further, it should be understood that reference to “between” two values or parameters herein includes (and describes) aspects that include those two values or parameters per se. For example, description referring to “between x and y” includes description of “x” and “y” per se.

The mass fractions disclosed herein can be converted to wt % by multiplying by 100.

Preferred embodiments of the present invention include a polyol produced by condensation polymerization of β-lactone monomers with monomers including hydroxyl functional groups such as diols, triols, polyols, and sugar alcohols in the presence of a condensation polymerization catalyst. In some embodiments, the β-lactone may be beta-butyrolactone, beta-valerolactone, beta-heptanolactone, beta-tridecanolactone, cis-3,4-dimethyloxetan-2-one, 4-(but-3-en-1-yl)oxetan-2-one, 4-(butoxymethyl)-2-oxetanone, 4-[[[(1,1-dimethylethyl)dimethylsilyl]oxy]methyl]-2-oxetanone, 4-[(2-propen-1-yloxy)methyl]-2-oxetanone, 4-[(benzoyloxy)methyl]-2-Oxetanone. In some embodiments, the β-lactones may be polymerized with diols including ethylene glycol, propylene glycol, 1,4-butanediol, diethylene glycol, bis(hydroxymethyl)octadecanol and 1,6-hexanediol. In some embodiments, the β-lactones may be polymerized with triols including glycerol, (D)-2-Deoxyribose, butane-1,2,3-triol, butane-1,2,3-triol, cyclohane-1,2,3-triol, cyclohexane-1,2,4-triol, and cyclohexane-1,3,5-triol. In some embodiments, the β-lactones may be polymerized with sugar alcohols including sorbitol, mannitol, xylitol, isomalt, and hydrogenated starch hydrolysates. The polyol polymer compositions have a number average molecular weight (“Mₙ”) in the range of 500 g/mol to about 250,000 g/mol.

In certain preferred embodiments, polyols have an Mₙ less than about 100,000 g/mol. In certain embodiments, polyols have an Mₙ less than about 70,000 g/mol. In certain embodiments, polyols have an Mₙ less than about 50,000 g/mol. In certain embodiments, polyols have an Mₙ between about 500 g/mol and about 40,000 g/mol. In certain embodiments, polyols have an Mₙ less than about 25,000 g/mol. In certain embodiments, polyols have an Mₙ between about 500 g/mol and about 20,000 g/mol. In certain embodiments, polyols have an Mₙ between about 500 g/mol and about 10,000 g/mol. In certain embodiments, polyols have an Mₙ between about 500 g/mol and about 5,000 g/mol. In certain embodiments, polyols have an Mₙ between about 1,000 g/mol and about 5,000 g/mol. In certain embodiments, polyols have an Mₙ between about 5,000 g/mol and about 10,000 g/mol. In certain embodiments, polyols have an Mₙ between about 500 g/mol and about 1,000 g/mol. In certain embodiments, polyols have an Mₙ between about 1,000 g/mol and about 3,000 g/mol. In certain embodiments, polyols have an Mₙ of about 5,000 g/mol. In certain embodiments, polyols have an Mₙ of about 4,000 g/mol. In certain embodiments, polyols have an Mₙ of about 3,000 g/mol. In certain embodiments, polyols have an Mₙ of about 2,500 g/mol. In certain embodiments, polyols have an Mₙ of about 2,000 g/mol. In certain embodiments, polyols have an Mₙ of about 1,500 g/mol. In certain embodiments, polyols have an Mₙ of about 1,000 g/mol.

In certain embodiments, at least 90% of the end groups of the polyol used are —OH groups. In certain embodiments, at least 95%, at least 96%, at least 97% or at least 98% of the end groups of the polyol used are —OH groups. In certain embodiments, more than 99%, more than 99.5%, more than 99.7%, or more than 99.8% of the end groups of the polyol used are —OH groups. In certain embodiments, more than 99.9% of the end groups of the polyol used are —OH groups.

In certain embodiments, it is advantageous if the polyol compositions have a substantial proportion of primary hydroxyl end groups. For polyols it may be preferable for some or most of the chain ends to consist of secondary hydroxyl groups. In certain embodiments, the polyols may be modified to increase the proportion of primary —OH end groups. This may be accomplished by reacting the secondary hydroxyl groups with reagents such as ethylene oxide, reactive lactones, and the like. In certain embodiments, the polyols may be modified with β-lactones, such as caprolactone and the like to introduce primary hydroxyl end groups.

The polymer of this invention will use bPL that can be produced from EO and CO according to the following general reaction schemes shown in FIGS. 1 and 2. In addition in this invention at least one of the EO and/or CO used to produce the bPL monomer will have a bio-content of at least 10% and preferably at least 20%, at least 30%, at least 40%, at least 50%, at least 60%, at least 70%, at least 80%, at least 90%, at least 95%, at least 99%, or 100%.

In preferred embodiments, comonomers, such as diols, tiols and polyols, may have contain carbon with a significant bio-content. In some variations, the comomers may have a bio-content of at least 10% and preferably at least 20%, at least 30%, at least 40%, at least 50%, at least 60%, at least 70%, at least 80%, at least 90%, at least 95%, at least 99%, or 100%.

In variations of the foregoing, the resulting beta-propiolactone copolymer will have a bio-content of greater than 0%, and less than 100%. In certain variations of the foregoing, the copolymer has a bio-content of at least 10%, at least 20%, at least 30%, at least 40%, at least 50%, at least 60%, at least 70%, at least 80%, at least 90%, at least 95%, at least 99%, at least 99.5%, at least 99.9%, or 100%.

In certain preferred embodiments, the polyols may comprise a terpolymer of a β-lactone monomer, hydroxyl functional group containing monomer, and one or more additional epoxides. The monomer of one or more epoxides may be selected from the group of propylene oxide, 1,2-butene oxide, 2,3-butene oxide, cyclohexene oxide, 3-vinyl cyclohexene oxide, epichlorohydrin, glicydyl esters, glycidyl ethers, styrene oxides, and epoxides of higher alpha olefins. In certain embodiments, such terpolymers may contain a majority of repeat units derived from ethylene oxide with lesser amounts of repeat units derived from one or more additional epoxides. In certain embodiments, terpolymers may contain about 50% to about 99.5% ethylene oxide-derived repeat units. In certain embodiments, terpolymers may contain greater than about 60% ethylene oxide-derived repeat units. In certain embodiments, terpolymers may contain greater than 75% ethylene oxide-derived repeat units. In certain embodiments, terpolymers may contain greater than 80% ethylene oxide-derived repeat units. In certain embodiments, terpolymers may contain greater than 85% ethylene oxide-derived repeat units. In certain embodiments, terpolymers may contain greater than 90% ethylene oxide-derived repeat units. In certain embodiments, terpolymers may contain greater than 95% ethylene oxide-derived repeat units.

In certain preferred embodiments, the polyols may comprise a terpolymer of a of a β-lactone monomer, a monomer having hydroxyl functional groups, and an additional β-lactone monomer. The β-lactone monomer may be chosen from the group of β-butyrolactone, β-valerolactone, β-heptanolactone, β-tridecanolactone, cis-3,4-dimethyloxetan-2-one, 4-(but-3-en-1-yl)oxetan-2-one, 4-(butoxymethyl)-2-oxetanone, 4-[[[(1,1-dimethylethyl)dimethylsilyl]oxy]methyl]-2-oxetanone, 4-[(2-propen-1-yloxy)methyl]-2-oxetanone, 4-[(benzoyloxy)methyl]-2-Oxetanone. In certain embodiments, β-propiolactone may be polymerized with β-butyrolactone and monomers having hydroxyl functional groups. In one embodiment, β-propiolactone may be polymerized with β-butyrolactone and 1,4-butanediol to form a polyol of the present invention.

In certain preferred embodiments, the β-lactone monomers of the present invention may be polymerized to form certain homopolymer poly-lactone oligomers (“poly-lactone oligomers”) which may be further polymerized with one or more other monomers having hydroxyl functional groups. The poly-lactone oligomers of the present invention may be characterized according to molecular weight distributions. In certain embodiments, poly-lactone oligomers have a Mₙ less than about 100,000 g/mol. In certain embodiments, poly-lactone oligomers have a Mₙ less than about 70,000 g/mol. In certain embodiments, poly-lactone oligomers have a Mₙ less than about 50,000 g/mol. In certain embodiments, poly-lactone oligomers have a Mₙ between about 500 g/mol and about 40,000 g/mol. In certain embodiments, poly-lactone oligomers have a Mₙ less than about 25,000 g/mol. In certain embodiments, poly-lactone oligomers have a Mₙ between about 500 g/mol and about 20,000 g/mol. In certain embodiments, poly-lactone oligomers have a Mₙ between about 500 g/mol and about 10,000 g/mol. In certain embodiments, poly-lactone oligomers have a Mₙ between about 500 g/mol and about 5,000 g/mol. In certain embodiments, poly-lactone oligomers have a Mₙ between about 1,000 g/mol and about 5,000 g/mol. In certain embodiments, poly-lactone oligomers have a Mₙ between about 5,000 g/mol and about 10,000 g/mol. In certain embodiments, poly-lactone oligomers have a Mₙ between about 500 g/mol and about 1,000 g/mol. In certain embodiments, poly-lactone oligomers have a Mₙ between about 1,000 g/mol and about 3,000 g/mol. In certain embodiments, poly-lactone oligomers have a Mₙ of about 5,000 g/mol. In certain embodiments, poly-lactone oligomers have a Mₙ of about 4,000 g/mol. In certain embodiments, poly-lactone oligomers have a Mₙ of about 3,000 g/mol. In certain embodiments, poly-lactone oligomers have a Mₙ of about 2,500 g/mol. In certain embodiments, poly-lactone oligomers have a Mₙ of about 2,000 g/mol. In certain embodiments, poly-lactone oligomers have a Mₙ of about 1,500 g/mol. In certain embodiments, poly-lactone oligomers have a Mₙ of about 1,000 g/mol. In certain preferred embodiments, the poly-lactone oligomers may be polypropiolactone oligomers.

In certain embodiments, the PPL oligomers may be polymerized with monomers having hydroxyl functional groups such as simple alcohols, diols, triols, and sugar alcohols. In some embodiments, the PPL oligomers may be polymerized with diols including ethylene glycol, propylene glycol, 1,4-butanediol, diethylene glycol, bis(hydroxymethyl)octadecanol and 1,6-hexanediol. In some embodiments, the PPL oligomers may be polymerized with triols including glycerol, (D)-2-Deoxyribose, butane-1,2,3-triol, butane-1,2,3-triol, cyclohane-1,2,3-triol, cyclohexane-1,2,4-triol, and cyclohexane-1,3,5-triol. In some embodiments, the PPL oligomers may be polymerized with sugar alcohols including sorbitol, mannitol, xylitol, isomalt, and hydrogenated starch hydrolysates.

In some variations of the foregoing, the polyol polymer has a bio-content of greater than 0%, and less than 100%. In certain variations of the foregoing, the polymer has a bio-content of at least 10%, at least 20%, at least 30%, at least 40%, at least 50%, at least 60%, at least 70%, at least 80%, at least 90%, at least 95%, at least 96%, at least 97%, at least 98%, at least 99%, at least 99.5%, at least 99.9%, at least 99.99%, or 100%.

In some variations, bio-content (also referred to as “bio-based content”) can be determined based on the following:

% Bio-content or Bio-based content=[Bio(Organic)Carbon]/[Total(Organic)Carbon]*100%, as determined by ASTM D6866(Standard Test Methods for Determining the Bio-based Content of Solid, Liquid, and Gaseous Samples Using Radiocarbon Analysis).

The bio-content of the polymers may depend based on the bio-content of the β-lactone used. For example, in some variations of the methods described herein, the β-lactone used to produce the polymers described herein may have a bio-content of greater than 0%, and less than 100%. In certain variations of the methods described herein, the β-lactone used to produce the polymers described herein may have a bio-content of at least 10%, at least 20%, at least 30%, at least 40%, at least 50%, at least 60%, at least 70%, at least 80%, at least 90%, at least 95%, at least 96%, at least 97%, at least 98%, at least 99%, at least 99.5%, at least 99.9%, at least 99.99%, or 100%.

In certain preferred variations, the β-lactone is β-propiolactone and it is entirely derived from renewable sources. In other variations, at least a portion of the β-propiolactone used is derived from renewable sources, and at least a portion of the β-propiolactone is derived from non-renewable sources.

The biobased-content of the β-propiolactone may depend on, for example, the bio-content of the ethylene oxide and carbon monoxide used. In some variations, both ethylene oxide and carbon monoxide are derived from renewable sources.

In some variations of the foregoing, the polymer has a biodegradability of at least 10%, at least 20%, at least 30%, at least 40%, at least 50%, at least 60%, at least 70%, at least 80%, at least 90%, at least 95%, at least 96%, at least 97%, at least 98%, at least 99%, at least 99.5%, at least 99.9%, at least 99.99%, or 100%.

In some variations of the foregoing, biodegradable is as defined and determined based on ASTM D5338-15 (Standard Test Method for Determining Aerobic Biodegradation of Plastic Materials Under Controlled Composting Conditions, Incorporating Thermophilic Temperatures).

Preferred embodiments of the present invention include a process for producing a biodegradable polyol having higher bio-content. The process includes the steps for combining at least an epoxide containing bio-content carbon, carbon monoxide containing bio-content carbon, and carbonylation catalyst in a carbonylation reaction zone at carbonylation conditions and producing a β-lactone intermediate. Then, the process includes a step for recovering β-lactone monomers from the β-lactone intermediate. Next, the process includes a step for polymerizing β-lactone monomers, monomers including hydroxyl functional groups, and a polymerization catalyst in a polymerization reaction zone to produce the biodegradable polyol.

In some embodiments, the polymerization of poly-lactone oligomers may include a catalyst such as an ionic initiator. In some embodiments, the ionic initiator has the general formula of M″X where M″ is cationic and X is anionic. In some embodiments, M″ is selected from the group consisting of Lit, Na⁺, K⁺, Mg²⁺, Ca²⁺, and Al³⁺. In some embodiments, M″ is Na⁺. In some embodiments, M″ is an organic cation. In some embodiments, the organic cation is selected from the group consisting of quaternary ammonium, imidazolium, and bis(triphenylphosphine)iminium. In some embodiments, the quaternary ammonium cation is tetraalkyl ammonium. In some embodiments, the polymerization reaction temperature can range from 25 deg C. to 180 deg C. In some embodiments the polymerization reaction temperature can range from 50 deg C. to 150 deg C.

In some embodiments, the β-lactone may be beta-butyrolactone, beta-valerolactone, beta-heptanolactone, beta-tridecanolactone, cis-3,4-dimethyloxetan-2-one, 4-(but-3-en-1-yl)oxetan-2-one, 4-(butoxymethyl)-2-oxetanone, 4-[[[(1,1-dimethylethyl)dimethylsilyl]oxy]methyl]-2-oxetanone, 4-[(2-propen-1-yloxy)methyl]-2-oxetanone, 4-[(benzoyloxy)methyl]-2-Oxetanone.

In some embodiments, the β-lactone monomers may be formed from carbonylation of an epoxide with carbon monoxide in the presence of a carbonylation catalyst. In certain preferred embodiments, the epoxide is ethylene oxide which may undergo a carbonylation reaction, with carbon monoxide, in the present of a carbonylation catalyst to produce a β-lactone. In some embodiments, the epoxide is selected from the group consisting of: propylene oxide, 1,2-epoxybutane, 2,3-epoxybutane, cyclohexene oxide; cyclopentane oxide, 1,2-epoxyhexane, 1,2-epoxydodecane, 2-cyclohexyloxirane, 3,3,3-Trifluoro-1,2-epoxypropane, styrene oxide, n-butyl glycidyl ether, tert-butyldimethylsilyl glycidyl ether, benzyl glycidyl ether.

In certain preferred embodiments, the combining step is performed in the presence of a carbonylation catalyst which comprises a metal carbonyl compound. In some embodiments, the metal carbonyl compound has the general formula [Q_{my}(CO)_{w}]ₓ, where: Q is any ligand and need not be present; M is a metal atom; y is an integer from 1 to 6 inclusive; w is a number such as to provide the stable metal carbonyl; and x is an integer from −3 to +3 inclusive. In some embodiments, M is selected from the group consisting of Co, and Rh.

In some embodiments, the carbonylation catalyst further comprises a Lewis acidic co-catalyst. In some embodiments, the metal carbonyl compound is anionic, and the Lewis acidic co-catalyst is cationic. In some embodiments, the metal carbonyl complex comprises a carbonyl cobaltate and the Lewis acidic co-catalyst comprises a metal-centered cationic Lewis acid.

In certain embodiments, a metal-centered cationic Lewis acid is a metal complex of formula [M′(L)b]c+, where, M′ is a metal, each L is a ligand, b is an integer from 1 to 6 inclusive, c is 1, 2, or 3; and where, if more than one L is present, each L may be the same or different.

In some embodiments, the Lewis acid includes a dianionic tetradentate ligand. In some embodiments, the dianionic tetradentate ligand is selected from the group consisting of: porphyrin derivatives; salen derivatives; dibenzotetramethyltetraazaannulene (“TMTAA”) derivatives; phthalocyaninate derivatives; and derivatives of the Trost ligand. In some embodiments, M′ is selected from the group consisting of Al, Cr, and Co. In some embodiments, the metal carbonyl complex comprises a carbonyl cobaltate and the Lewis acidic co-catalyst comprises a metal-centered cationic porphyrins.

In certain embodiments, a carbonylation catalyst comprises a carbonyl cobaltate in combination with an aluminum porphyrin compound as a Lewis-acidic component. In some embodiments, a carbonylation catalyst comprises [(TPP)Al][Co(CO)4]. In some embodiments, a carbonylation catalyst comprises [(CITPP)Al][Co(CO)4].

The embodiments described herein are not intended to be limited to the aspects shown, but are to be accorded the widest scope consistent with the principles and features disclosed herein.

1. A biodegradable polyol comprising:
a. a monomer of β-lactone derived from the carbonylation reaction of an epoxide with carbon monoxide, said epoxide having a bio-content greater than 10% and said carbon monoxide having a bio-content greater than 10%;
b. wherein said monomer of β-lactone is polymerized with at least one monomer comprising a diol to produce the biodegradable polyol.

2. The biodegradable polyol from claim 1, wherein said β-lactone is formed by reacting an epoxide with carbon monoxide.

3. The biodegradable polyol from claim 2, wherein said epoxide is ethylene oxide comprised of bio-content carbons.

4. The biodegradable polyol from claim 2, wherein said carbon monoxide is comprised of bio-content carbons.

5. The biodegradable polyol from claim 1, wherein said β-lactone is β-propiolactone.

6. The biodegradable polyol from claim 1, wherein said at least one monomer including, a hydroxyl functional group includes a diol.

7. The biodegradable polyol from claim 1, wherein said diol is 1,4-butanediol.

8. The biodegradable polyol from claim 1, wherein said at least one monomer including a hydroxyl functional group includes a triol.

9. The biodegradable polyol from claim 10, wherein said triol is glycerol.

10. The biodegradable polyol from claim 1, wherein said at least one monomer including a hydroxyl functional group includes erythritol.

11. The biodegradable polyol from claim 1, wherein said at least one monomer including a hydroxyl functional group includes a xylitol.

12. The biodegradable polyol from claim 1, wherein the biodegradable polyol is reacted with a β-lactone to produce a modified biodegradable polyol.

13. The modified biodegradable polyol from claim 14, wherein said β-lactone is β-propiolactone.

14. The biodegradable polyol from claim 1, wherein the biodegradable polyol has a biocontent of at least 50%.

15. The biodegradable polyol from claim 1, wherein the biodegradable polyol has a biocontent of at least 75%.

16. The biodegradable polyol from claim 1, wherein the biodegradable polyol has a biocontent of at least 95%

17. A biodegradable polyol comprising:
a. a monomer of a first β-lactone derived from the carbonylation reaction of an epoxide with carbon monoxide, said epoxide having a bio-content greater than 10% and said carbon monoxide having a bio-content greater than 10%;
b. said monomer of said first β-lactone polymerized with a monomer of a second β-lactone and a monomer having at least two hydroxyl functional groups.

18. A biodegradable polyol comprising:
a. a monomer of a poly β-lactone oligomer having monomers derived from the carbonylation reaction of an epoxide with carbon monoxide, said epoxide having a bio-content greater than 10% and said carbon monoxide having a bio-content greater than 10%;
b. said monomer of said poly β-lactone oligomer polymerized with a monomer having at least two hydroxyl functional groups.
